(19) United States
(12) Patent Application Publication
(10) Pub. No.: US 2005/0097759 A1
(43) Pub. Date: May 12, 2005

(54) Knife with movable handle

(76) Inventor: Hiroshi Igarashi, Lake Oswego, OR (US)

Correspondence Address: KOLISCH HARTWELL, P.C., 520 S.W. YAMHILL STREET, SUITE 200, PORTLAND, OR, 97204, US

(21) Appl. No.: 10/958,687

(22) Filed: Oct. 4, 2004

Related U.S. Application Data
(60) Provisional application No. 60/508,562, filed on Oct. 3, 2003.

(51) Int. Cl. B26B 7/00

(52) U.S. Cl. 30/277.4; 30/340

(57) ABSTRACT

A knife may include a base including first and second ends; a handle assembly connected to the base, including a handle, and configured to allow the handle to be moved relative to the base; and a blade extending from the second end of the base. In some examples, the distance between the handle and the base is adjustable. In some examples, the handle may be locked in position relative to the base.

### CROSS-REFERENCE TO RELATED APPLICATIONS

This application claims priority under 35 U.S.C. § 119(e) to U.S. Provisional Patent Application Ser. No. 60/508,562 entitled “Knife with Rotatable Handle,” filed Oct. 3, 2003, the entire disclosure of which is herein incorporated by reference for all purposes.

### BACKGROUND

The present disclosure relates generally to knives and more specifically to a knife with a movable handle.

Electric knives and cutting tools where the blades may be mounted in different orientations are shown in U.S. Pat. Nos. 3,303,563; 3,861,039; and 5,2981,767, the disclosures which are hereby incorporated by reference for all purposes. Other electric knives and electric tools are shown in U.S. Pat. Nos. 4,107,819; 4,631,827; 4,891,884, 6,434,836; and D314,691, the disclosures of which are herein incorporated by reference for all purposes.

### SUMMARY

One embodiment provides a knife. The knife may include a base including first and second ends; a handle assembly connected to the base, including a handle, and configured to allow the handle to be moved relative to the base; and a blade extending from the second end of the base. In some examples, the distance between the handle and the base is adjustable. In some examples, the handle may be locked in position relative to the base.

### BRIEF DESCRIPTION OF THE DRAWINGS

FIG. 1 is an isometric view of a knife with a blade and a movable handle in substantially the same plane.

FIG. 2 is a side view of the knife of FIG. 1 with the handle in a plane orthogonal to the plane of the blade.

FIG. 3 is an end view of the knife of FIG. 2.

FIG. 4 is a side view of another embodiment of a knife with a movable handle showing the handle in a plane transverse to a plane of the blade.

FIG. 5 is an end view of the knife of FIG. 4.

FIG. 6 is a partial fragmentary side view of a portion of the knife of FIG. 1.

FIG. 7 is a partial side view of another embodiment of a knife with an adjustable handle.

### DETAILED DESCRIPTION

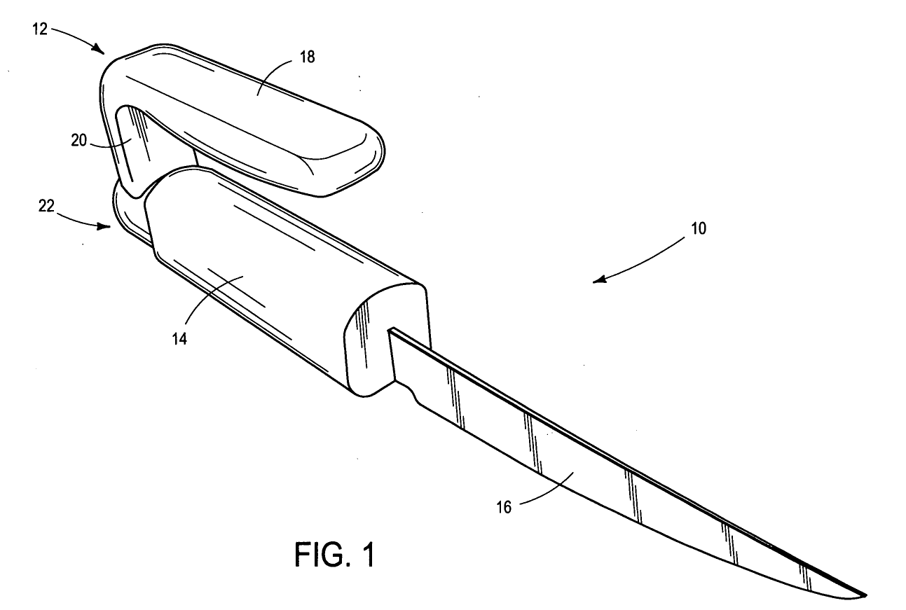

Referring to the drawings, and more specifically to FIGS. 1-3 and 6, an illustration of a first embodiment of a knife is shown generally at 10. Knife 10 may include a handle assembly 12, a base 14, and a blade 16.

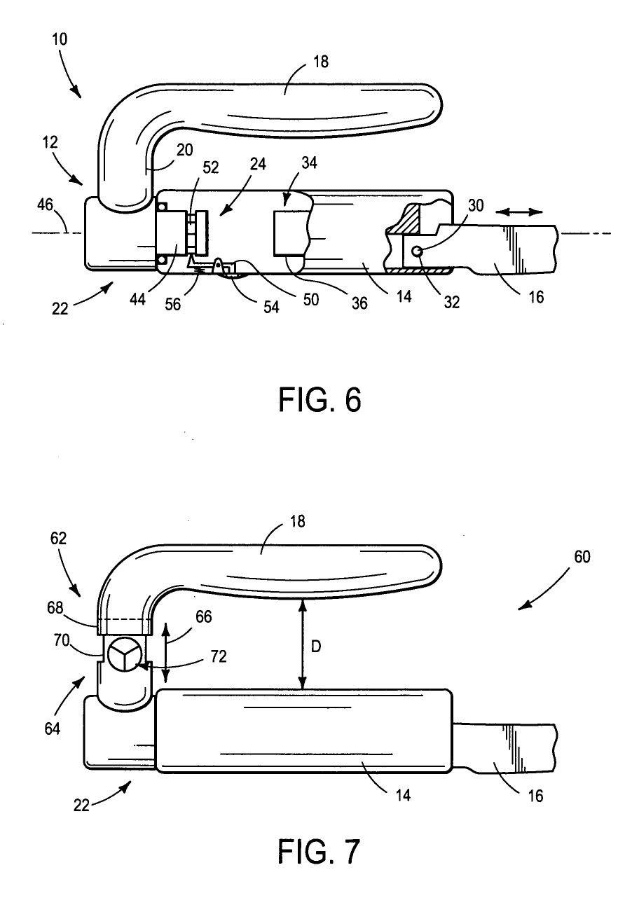

Handle assembly 12 may include a handle 18, a spacer 20, and a handle-movement mechanism 22. As shown in FIG. 6, handle assembly 12 may also include a locking assembly 24 described further below. Handle 18 may be adapted to be held in a user's hand or grasped by a user when using the knife. It should be appreciated that the handle may be disposed such that a portion of a user's hand may rest on base 14. Typically, the handle will be spaced from the shaft, such as by distance D, such that a user may wrap her or his hand around the handle with the fingers or other part of the hand extending between the handle and the base.

Base 14 may be elongate and extend along a base axis 26 between opposite ends 14A and 14B. Base 14 may be configured to receive securely blade 16. In some embodiments, various types of blades may be used interchangeably with base 14. In those embodiments, stem 14 may include a locking mechanism 28 configured to lock the selected blade. Various blade-locking mechanisms may be used. Shown in FIG. 6 is a locking mechanism 28 in an exemplary form as the combination of a detent 30 that releasably extends into an indent or aperture 32 in an end of the blade. A blade-drive mechanism 34, typically including an electric motor 36 or other power-supplying device, may be contained within base 14 to drive the blade with a lengthwise-reciprocating or other suitable cutting motion. Blade 16 may be a single blade or a combination of blade elements, and may be removable or permanently mounted to base 14.

Although described as an electric knife, it should be appreciated that the knife may be an electric slicer, an electric fillet knife, battery-powered knife, or other powered knife or tool. Moreover, in some embodiments, the knife may be a non-powered knife, and may be movable or fixed in position relative to the base.

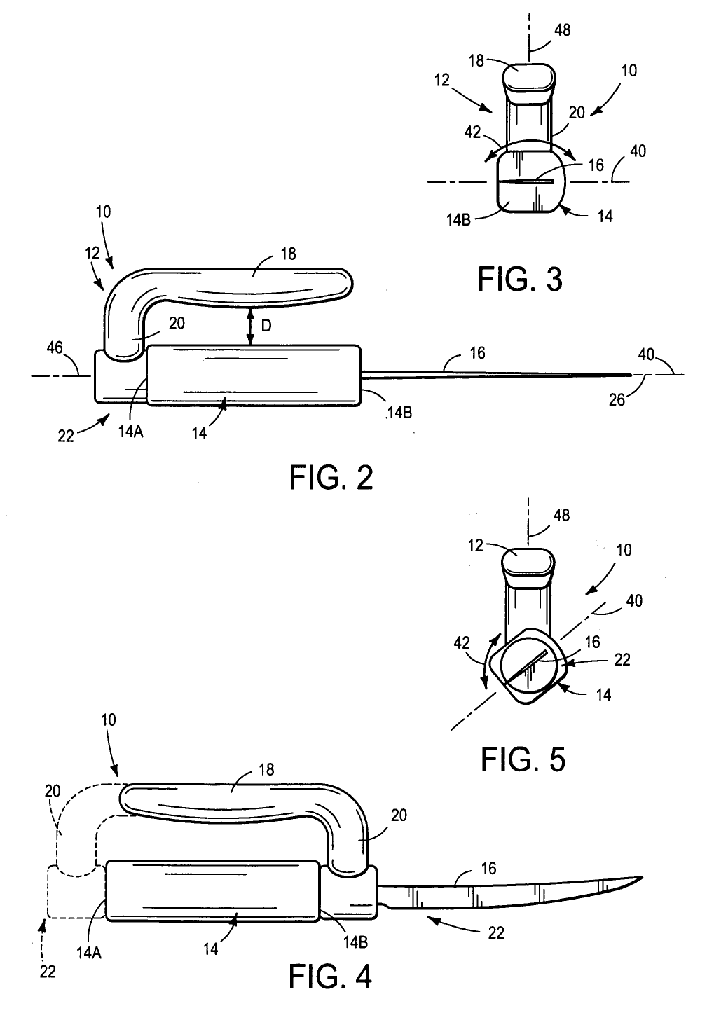

As described above, blade 16 may extend from base 14. Blade 16 may include a cutting edge 38. Cutting edge 38 and blade 16 may be disposed generally along a plane 40, which extends through the blade and the cutting edge of the blade. This plane is referred to herein as the cutting plane 40, shown particularly in FIGS. 2 and 3.

Knife 10 may be configured to enable a user to position selectively the handle relative to the blade. A user may find that the pivoting of the handle enables easier cutting of a material. Moreover, a user may want to make angled cuts, horizontal cuts, and/or vertical cuts in a product while using substantially the same grip on the knife. By providing a pivotable handle, a user may easily adjust the knife and the user's hand position to more easily cut a product as desired. For example, such adjustment of the handle may enable a user to more easily slice, clean, cut, etc. food products, such as meat or fish.

In FIG. 1, handle 18 may be pivotably coupled to base 14 through movement mechanism 22. Movement mechanism 22 may be configured for the handle to pivot relative the base and/or blade. For example, the handle may be pivoted in a clockwise and/or counterclockwise direction as indicated by arrow 42 shown in FIG. 3. Mechanism 22 may be any suitable mechanism providing movement of handle 18 relative to blade 16. For example, mechanism 22 may include a shaft 44 supported for rotation about a pivot axis 46 in base 14. As shown, axis 46 is coincident with base axis 26. Axes 46 and 26 may also be parallel, transverse, intersecting, non-intersecting, or a combination of these characteristics. Optionally, movement mechanism 22 may provide movement of handle 18 along other regular or irregular paths of movement relative to base 14 and/or blade 16. It is sufficient that movement mechanism 22 move between a plurality of positions relative to base 14 or blade 16. In this example, handle 18 may be considered to be disposed along a plane 48 containing axis 46, as shown in FIG. 3.

A user may select a position and lock the handle in place such that the handle is offset from a first position shown in FIG. 1 in which the handle is in the cutting plane 40. For example, the handle, and thereby the plane 48 of the handle, may be at 90 degrees from the blade and base, and thereby the cutting plane 40, as shown in FIGS. 2 and 3. In some embodiments, the user may lock the handle 45 degrees (as shown in FIGS. 4 and 5), 60 degrees, and/or any other suitable angle, including full rotation, from the blade.

Any suitable locking assembly 24 may be used to lock handle. For example, FIG. 6 illustrates a locking assembly 240, which includes any structure configured to lock handle 18 in a selected position. In this example, locking assembly 24 may include a locking element 50 pivotally mounted on base 14 to pivot between a locking position, where the locking element engages handle assembly 12 (such as shaft ridges 52) to lock the handle, and an unlocking position, where the locking element disengages shaft 44 to allow the user to pivot the handle. Locking assembly 24 also may include an actuator 54, which is operatively connected to locking element 50 to pivot the locking element. That actuator may be manipulable on the base for easy locking or unlocking by the user. The actuator also may be recessed to prevent accidental unlocking of handle 18. Additionally, the locking assembly may include a bias element 56 to bias locking element 50 toward the locking position.

It should be noted that the handle assembly may be attached at any point to the base and/or blade, and may be attached at more than one place. For example, FIGS. 1 and 2 illustrate the handle assembly pivotally connected to the rear portion of base 14. In some embodiments (as shown in FIGS. 4 and 5), the handle assembly may be pivotally attached to the front portion of base 14. Optionally, the handle assembly may be mounted to the base at more than one place, such as at both ends 14A and 14B of the base. The additional mounting at end 14A is illustrated in dashed lines in FIG. 4. Movement assembly 22 enables the handle to be pivoted about the base to a user-selected position.

Another embodiment of a knife is illustrated in the drawing of FIG. 7. Specifically, a knife 60, similar to knife 10, with a handle 18, a base 14, and a blade 16 is shown in FIG. 7. Base 14 may be adapted to receive blade 16. As discussed above, handle 18 may be pivotally connected to base 14, as part of a handle assembly 62, such that the handle may be selectively positioned relative to blade 16.

Handle assembly 62 may further include a spacer assembly 64 that spaces handle 18 from base 14. Spacer assembly 64 may include any structure configured to allow the user to change the distance D between base 14 and handle 18, such as by selectively lengthening and/or shortening spacer assembly 64, as indicated by arrow 66 provided by telescoping elements 68 and 70. For example, a user may shorten the spacer assembly, thus bringing the handle 18 closer to base 14. Similarly, a user may desire to lengthen spacer assembly 64, such that handle 18 is further from base 14. The ability to adjust the length of the spacer portion may enable the user to customize the knife for their use and comfort.

For example, a user with small hands may desire to have a small space between the handle and the base, while a user with large hands may prefer to have a large space between the handle and the base. Moreover, depending on the use or the material to be cut, the user may selectively adjust the length of distance D using the spacer assembly. For example, a user may desire to have the handle close to the base when the handle of the knife is pivoted such that the handle extends in a different plane than the cutting edge of the knife, or vice versa. Likewise, a user may desire to adjust the distance between the handle and the base when using the handle in the same plane as the cutting edge of the blade.

Spacer assembly 64 may include a spacer locking mechanism 72, which may include any suitable structure configured to lock the spacer assembly at the desired length. The locking mechanism 72 may include any structure, such as latches, hooks, detents, threaded elements, etc., configured to lock spacer assembly 64.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the descriptions recite “a” or “a first” element or the equivalent thereof, such descriptions should be understood to include incorporation of one or more such elements, neither requiring nor excluding two or more such elements.

Inventions embodied in various combinations and subcombinations of features, functions, elements, and/or properties may be claimed in this and/or a future application. Such claims, whether they are directed to a different invention or directed to the same invention, whether different, broader, narrower or equal in scope to any previous or current claims, are also regarded as included within the subject matter of the inventions of the present disclosure.

1. A knife, comprising:
a base including first and second ends;
a handle assembly connected to the base, including a handle, and configured to allow the handle to be moved relative to the base; and
a blade extending from the second end of the base.

2. The knife of claim 1, wherein the base extends along a first axis and the handle revolves about a second axis generally parallel to the first axis.

3. The knife of claim 1, wherein the handle assembly is configured to allow the handle to revolve around the base.

4. The knife of claim 1, wherein the handle extends along the base.

5. The knife of claim 4, wherein the handle extends generally parallel to and spaced from the base.

6. The knife of claim 1, wherein the blade is removably connected to the base.

7. The knife of claim 6, further comprising a locking mechanism configured to lock the blade to the base.

8. The knife of claim 1, wherein the handle assembly is configured to allow the handle to be positioned in a plurality of positions relative to the base, the handle assembly further including a locking assembly configured to lock the handle relative to the base in at least one of the plurality of positions.

9. The knife of claim 1, wherein the handle assembly is connected to at least one of the first and second ends of the base.

10. The knife of claim 1, wherein the handle assembly includes a spacer connected to the handle and configured to be adjusted selectively to vary a distance between the handle and the base.

11. The knife of claim 1, wherein the handle assembly is generally L-shaped.

12. The knife of claim 1, further comprising a motor contained within the base and configured to reciprocate the at least one blade.

13. An electric knife, comprising:
an elongate base including opposite ends along a first axis;
a handle assembly connected to the base, having a handle, and configured to allow the handle to revolve around the base about a second axis passing through the first and second ends of the base, thereby providing plural handle positions around the base;
a blade connected to an end of the base; and
a motor contained within the base and configured to reciprocate the blade.

14. The electric knife of claim 13, wherein the blade is removably connected to the second end of the base.

15. The electric knife of claim 14, further comprising a locking mechanism configured to lock the blade to the base.

16. The electric knife of claim 13, wherein the handle assembly further including a locking assembly configured to lock the handle in at least one of the plural positions.

17. The electric knife of claim 13, wherein the handle assembly is connected to at least one of the ends of the base.

18. The electric knife of claim 13, wherein the handle assembly includes a spacer configured to be adjusted to vary a distance between the grip portion and the base.

19. The electric knife of claim 13, wherein the handle assembly is generally L-shaped.

20. A knife, comprising:
an base including first and second ends;
a handle assembly including a handle and a spacer connecting the handle to the base, base the spacer being configured to be adjusted to vary the distance between the handle and the base; and
a blade connected to the second end of the base.
